(19) United States
(12) Patent Application Publication
(10) Pub. No.: US 2020/0381776 A1
(43) Pub. Date: Dec. 3, 2020

(54) NOVEL SOFT MATERIALS BASED ON BORON COMPOUNDS

(71) Applicant: Toyota Motor Engineering & Manufacturing North America, Inc., Plano, TX (US)

(72) Inventors: Rana Mohtadi, Northville, MI (US); Oscar Tutusaus, Ann Arbor, MI (US)

(21) Appl. No.: 16/424,849

(22) Filed: May 29, 2019

(51) Int. Cl. H01M 10/0564

(52) U.S. Cl. CPC H01M 10/0564; H01M 2300/0065

(57) ABSTRACT

Soft solid state electrolyte compositions for secondary electrochemical cell are composed of a metal salt dispersed or doped in a soft solid matrix. The matrix includes an organic cation and a boron cluster anion. The metal salt has a metal cation and an anion. Compared with competing solid electrolytes, the disclosed electrolyte compositions are soft, allowing for lower molding pressures and showing high ionic conductivity.

### TECHNICAL FIELD

The present disclosure relates generally to soft solid electrolytes for use in secondary batteries, and to boron cluster chemistry.

### BACKGROUND

Solid-state electrolytes provide many advantages in secondary battery design, including mechanical stability, no volatility, and ease of construction. Existing inorganic solid-state electrolytes displaying high ionic conductivity are usually hard materials that fail to maintain appreciable contact with the electrode materials through battery cycling. Organic solid-state electrolytes, like polymers, overcome the latter issue due to their reduced hardness; however, these suffer from poor ionic conductivity.

Those solid-state electrolytes having appreciable ionic conductivity are generally based on organic ionic liquid crystals (OIPCs). These materials depend on a solid-solid phase transition to achieve high conductivity. OIPC-based materials can suffer from difficulties, including low melting points and/or low temperature windows of the conducting phase that limit their applicability.

Thus, it would be desirable to provide improved solid-state electrolytes that rival the conductivity of OIPC-based electrolytes but do not rely on a phase transition with its attendant limitations.

### SUMMARY

This section provides a general summary of the disclosure, and is not a comprehensive disclosure of its full scope or all of its features.

In one aspect, a solid electrolyte composition for use in a secondary battery is disclosed. The electrolyte composition includes a soft solid matrix of the formula GₚA, wherein G is an organic cation from among a list of possible cations, p is 1 or 2; and A is a boron cluster anion. The electrolyte composition further includes a metal salt having a metal cation and a metal salt anion. The metal salt anion can optionally be a boron cluster anion that is the same as or different from the boron cluster anion, A, of the soft solid matrix.

In some implementations, the boron cluster anion, A, of the soft solid matrix is, the boron cluster anion of the metal salt, if present is, or boron cluster anions are, independently, defined by any of the following anion formulae: [B_{y}H_{(y-z-i)}R_{z}Xᵢ]²⁻, [CB_{(y-1)}H_{(y-z-i)}R_{z}Xᵢ]⁻, [C₂B_{(y-2)}H_{(y-t-j-1)}RₜXⱼ]⁻, [C₂B_{(y-3)}H_{(y-t-j)}RₜXⱼ]⁻ or [C₂B_{(y-3)}H_{(y-t-j-1)}RₜXⱼ]²⁻. In various implementations, y can be an integer within a range of 6 to 12; (z+i) can be an integer within a range of 0 to y; (t+j) can be an integer within a range of 0 to (y−1); and X can be F, Cl, Br, I, or a combination thereof. R can be an organic substituent, hydrogen, or a combination thereof.

These and other features of the method for forming an soft electrolyte such as an OIPC and the electrochemical cell having the same will become apparent from the following detailed description when read in conjunction with the figures and examples, which are intended to be illustrative and not exclusive.

### BRIEF DESCRIPTION OF THE DRAWINGS

Various aspects and advantages of the invention will become apparent and more readily appreciated from the following description of the embodiments taken in conjunction with the accompanying drawings, of which:

FIG. 1A is a perspective schematic view of a representative boron cluster anion of the present disclosure, closo-[B₁₂H₁₂]²⁻;

FIG. 1B is a perspective schematic view of a boron cluster anion of the present disclosure, closo-[CB₁₁H₁₂]⁻;

FIG. 1C is a perspective schematic view of a boron cluster anion of the present disclosure, closo-[C₂B₁₀H₁₁]⁻;

FIG. 2A is a plot of Differential Scanning calorimetry (DSC) data for a soft solid matrix (solid matrix) of an electrolyte of the present teachings, N-methyl-N-butyl pyrrolidinium closo-[CB₁₁H₁₂]⁻;

FIG. 2B is a plot of Differential Scanning calorimetry (DSC) data for a solid matrix of the present teachings, triethylhexylphosphonium closo-[CB₁₁H₁₂]⁻ doped with LiCB₁₁H₁₂;

FIG. 3 is a plot of ionic conductivity for multiple solid matrices of the present teachings, each having a closo-[CB₁₁H₁₂]⁻ anion;

FIG. 4 is a plot showing conductivity as a function of temperature for a solid matrix of the present teachings, at two applied pressures;

FIG. 5 is a plot of ionic conductivity in N-methyl-N-butyl pyrrolidinium CB₁₁H₁₂ doped with LiCB₁₁H₁₂, inset with a photographic image of the soft electrolyte; and

FIG. 6 is a plot of ionic conductivity of different soft electrolytes of the present teachings, having a 1:1 molar ratio of LiCB₉H₁₀:LiCB₁₁H₁₂ in N-methyl-N-butyl pyrrolidinium CB₉H₁₀ or N-methyl-N-butyl pyrrolidinium CB₁₁H₁₂.

### DETAILED DESCRIPTION

The present teachings provide soft electrolyte compositions similar to organic ionic liquid crystals (OIPCs). The soft electrolyte compositions are typically solid at battery operating temperatures but have unusually high ionic conductivity due to a highly entropic, plastic-like molecular structure.

Soft electrolyte compositions of the present teachings include a metal boron cluster salt, and a soft solid matrix (solid matrix) which is doped with the salt. The solid matrix includes a boron cluster anion and an organic cation having flexible and/or asymmetrical substituents. The resulting electrolytes form soft solids having a plastic or glass-like, highly entropic molecular structure that yields high ionic mobility and conductivity.

Thus, a soft solid electrolyte composition (referred to hereinafter simply as, “the electrolyte composition”) for use in secondary batteries is disclosed. The electrolyte composition includes a solid matrix having a formula GₚA, where G is an organic cation, A is a boron cluster anion, and p is either one or two. In some implementations, the organic cation can include at least one of an ammonium and a phosphonium cation, such as the examples shown below as Structures 1-4.

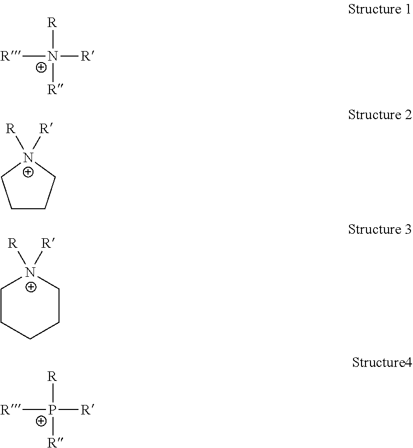

where R, R′, and where present R″ and R′″ is each, independently a substituent belonging to any of: group (i) a linear, branched-chain, or cyclic C1-C8 alkyl or fluoroalkyl group; group (ii) a C6-C9 aryl or fluoroaryl group; group (iii) a linear, branched-chain, or cyclic C 1-C8 alkoxy or fluoroalkoxy group; group (iv) a C6-C9 aryloxy or fluoroaryloxy group, group (v) amino; and group (vi) a substituent that includes two or more moieties as defined by any two or more of groups (i)-(v). The substituents R, R′, and where present R″ and R′″ can be alternatively referred to hereinafter as a “plurality of organic substituents. In general, the organic cation will have some degree of asymmetry with respect to the size and distribution of substituents. Thus, at least one of R, R′, R″ and R′″ will be different from the others, and the cation will preferably not include two pairs of substituents.

In certain particular implementations, the organic cation can be selected from the group including: N-methyl-N-propylpyrrolidinium (referred to hereinafter as “Pyr13”); N-methyl-N,N-diethyl-N-propylammonium (N1223); N,N-diethyl-N-methyl-N-(2-methoxyethyl)-ammonium (DEME); N-methyl-N-propylpiperidinium (referred to hereinafter as “Pip13”); N-methyl-N-(2-methoxyethyl)-pyrrolidinium (Pyr12_{O}1); trimethylisopropylphosphonium (P111ᵢ4); methyltriethylphosphonium (P1222); methyltributylphosphonium (P1444); N-methyl-N-ethylpyrrolidinium (Pyr12); N-methyl-N-butylpyrrolidinium (Pyr14); N,N,N-triethyl-N-hexyl ammonium (N2226); triethylhexylphosphonium (P2226); and N-ethyl-N,N-dimethyl-N-butylammonium (N4211). It is to be understood that, in some implementations, G can include more than one of the aforementioned cations. It is to be understood that when p equals two, the two organic cations contained in the stoichiometric unit of the solid matrix can be the same cation or can be two different cations.

As used herein, the phrase “boron cluster anion” generally refers to an anionic form of any of the following: a borane having 6-12 boron atoms with a net −2 charge; a carborane having 1 carbon atom and 5-11 boron atoms in the cluster structure with a net −1 charge; a carborane having 2 carbon atoms and 4-10 boron atoms in the cluster structure with a net −1 or −2 charge. In some variations, a boron cluster anion can be unsubstituted, having only hydrogen atoms in addition to the aforementioned. In some variations, a boron cluster anion can be substituted, having: one or more halogens replacing one or more hydrogen atoms; one or more organic substituents replacing one or more hydrogen atoms; or a combination thereof.

In some implementations, the boron cluster anion can be an anion having any formula of:

[B_{y}H_{(y-z-i)}R_{z}Xᵢ]²⁻ Anion Formula I,

[CB_{(y-1)}H_{(y-z-i)}R_{z}Xᵢ]⁻ Anion Formula II,

[C₂B_{(y-2)}H_{(y-t-j-1)}RₜXⱼ]⁻ Anion Formula III,

[C₂B_{(y-3)}H_{(y-t-j)}RₜXⱼ]⁻ Anion Formula IV, or

[C₂B_{(y-3)}H_{(y-t-j-1)}RₜXⱼ]²⁻ Anion Formula V,

wherein y is an integer within a range of 6 to 12; (z+i) is an integer within a range of 0 to y; (t+j) is an integer within a range of 0 to (y-1); and X is F, Cl, Br, I, or a combination thereof. Substituent R as included in Anion Formulae I-V can be any organic substituent or hydrogen.

It is to be understood that X can be F, Cl, Br, I, or a combination thereof, this indicates that when i is an integer within a range of 2 to y, or j is an integer within a range of 2 to (y-1), this indicates that a plurality of halogen substituents is present. In such a situation, the plurality of halogen substituents can include F, Cl, Br, I, or any combination thereof. For example, a boron cluster anion having three halogen substituents (i.e. where i or j equals 3), the three halogen substituents could be three fluorine substituents; 1 chlorine substituent, 1 bromine substituent, and 1 iodine substituent; or any other combination.

In many implementations, the boron cluster anion can include any of a substituted or unsubstituted closo-boron cluster anion. In some implementations, the boron cluster anion will be a closo-boron cluster anion, such as closo-[B₆H₆]²⁻, closo-[B₁₂H₁₂]²⁻, closo-[CB₁₁H₁₂]⁻, or closo-[C₂B₁₀H₁₁]⁻.

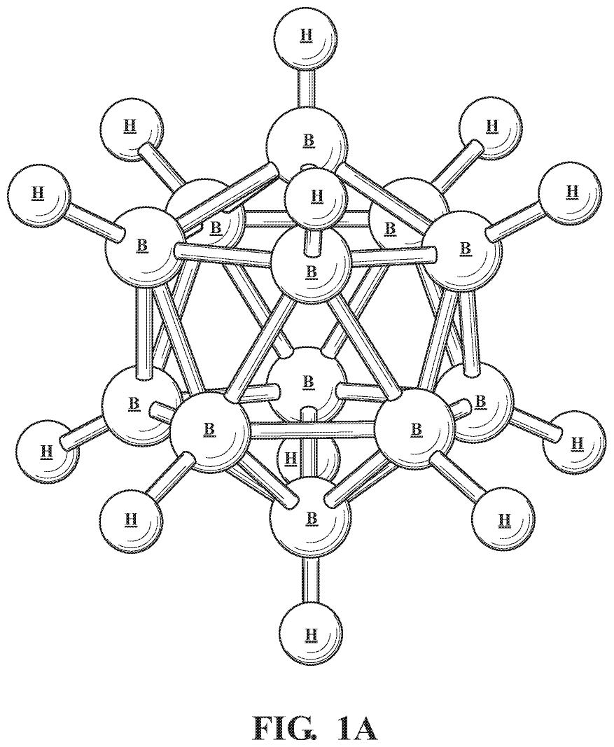

FIGS. 1A-1C show structures of exemplary unsubstituted boron cluster anions according to Anion Formulae I-V, respectively. Specifically, FIGS. 1A-1C show closo-[B₁₂H₁₂]²⁻, closo-[CB₁₁H₁₂]⁻, closo-[C₂B₁₀H₁₁]⁻, respectively. The exemplary closo-[C₂B₂H₁₁]⁻ anion of Anion Formula III is shown as a 1,2-dicarba species, however it will be appreciated that such a closo-icosahedral dicarba species can alternatively be 1,7- or 1,12-dicarba. More generally, it is to be understood that the required carbon atoms of Anion Formulae III, IV and V can occupy any possible positions in the boron cluster skeleton. It is also to be understood that non-hydrogen substituents, when present on a boron cluster anion, can be attached at any position in the boron cluster skeleton, including at vertices occupied by either boron or carbon, where applicable.

In some implementations, the electrolyte composition exhibits no phase transition below 80° C. and at standard pressure, as determined by DSC.

In some implementations, the electrolyte composition exhibits ionic conductivity greater than 10⁻¹⁰ S/cm in the solid state. It will additionally be noted that soft solid electrolytes of the present teachings are substantially softer than most current state-of-the-art solid electrolytes. For example, the elastic modulus of a typical sulfide solid state electrolyte is approximately 26 gigapascals (GPa). In contrast, a soft solid electrolyte having a solid matrix of Pyr14:CB₉H₁₀ with 80% metal salt consisting of a 1:1 molar ratio of LiCB₉H₁₀:LiCB₁₁H₁₂ has elastic modulus (a measure of hardness) of only 0.214 GPa. Similarly, a soft solid electrolyte having a solid matrix of Pyr14:CB₁₁H₁₂ with 45% LiCB₁₁H₁₂ metal salt has elastic modulus of only 2.36 GPa. Thus, in various implementations, the electrolyte composition can have elastic modulus less than about 10 GPa, or less than about 1 GPa, or less than about 0.5 GPa.

The electrolyte composition also includes ametal salt having a metal cation and anion. The anion associated with and/or derived from the metal salt can be referred to hereinafter as “the metal salt anion.” The metal salt will generally be selected on the basis of the electrochemistry of the battery in which the electrolyte composition will be used. In different variations, the metal cation can be Li⁺, Na⁺, Mg²⁺, Ca²⁺, or any other electrochemically suitable cation.

In some implementations, the metal salt anion can be any boron cluster anion of the types described above. In some such implementations of the electrolyte, the boron cluster anion of the metal salt can be the same as the boron cluster anion of the soft solid electrolyte, and in some implementations, the the two boron cluster anions can be different. In other variations, the metal salt anion can be any anion suitable for use in battery chemistry, such as TFSI, BF₄, PF₆, or FSI.

The solid matrix will generally be doped with the metal salt to form the electrolyte composition. Doping can be performed by attaining intimate contact between matrix salt and doping salt. One method to achieve this is to dissolve the dopant salt in the molten organic salt matrix (melt infusion). Another method is by dissolving all components in a solvent, mixing and removing the solvent to yield a solid material. Note that conditioning of the material using hand milling or ball milling prior or after melt infusion can be applied.

In some implementations, the electrolyte composition will include metal salt present at a molar ratio, relative to solid matrix, within a range of about 1:100 to about 100:1. More preferably, in some implementations, the electrolyte composition will include metal salt present at a molar ratio, relative to solid matrix, within a range of about 5:100 to about 1:1.

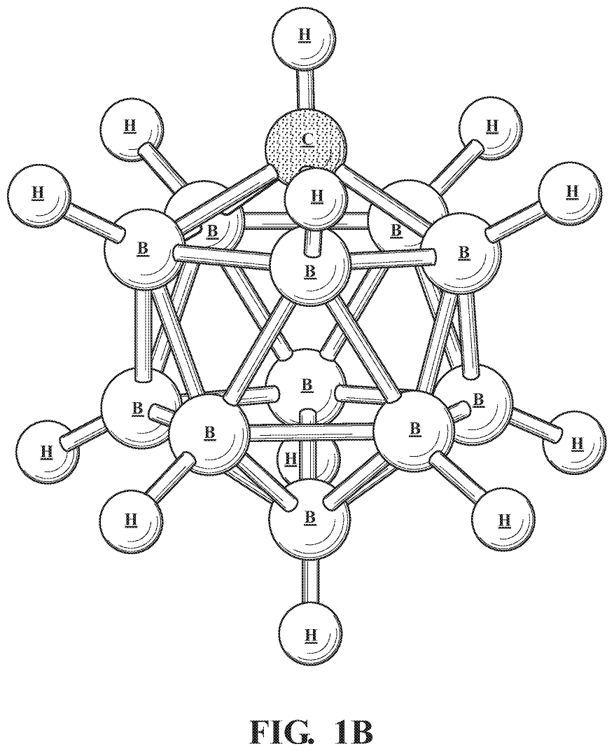

FIGS. 2A and 2B shows a plot of Differential Scanning calorimetry (DSC) data for a soft solid matrix (solid matrix) of the present teachings: Pyr14: CB₁₁H₁₂ and P2226: CB₁₁H₁₂. It is to be noted that no phase transitions are found below 100° C. and 95° C., respectively.

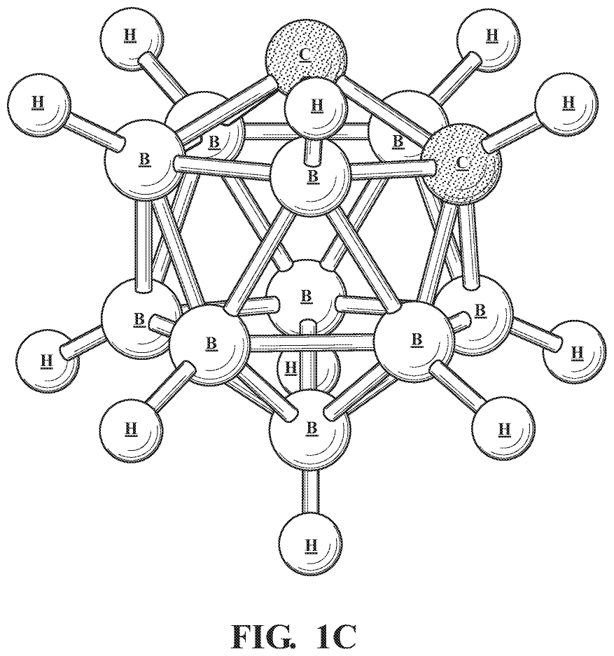

FIG. 3 is a plot of ionic conductivity for neat solid matrix of the present teachings having a closo-[CB₁₁H_{12]}⁻ anion. The results of FIG. 3, along with those of FIGS. 2A and 2B, establish that the materials have appreciable ionic conductivities below 95° C., despite not having any phase transition below that temperature.

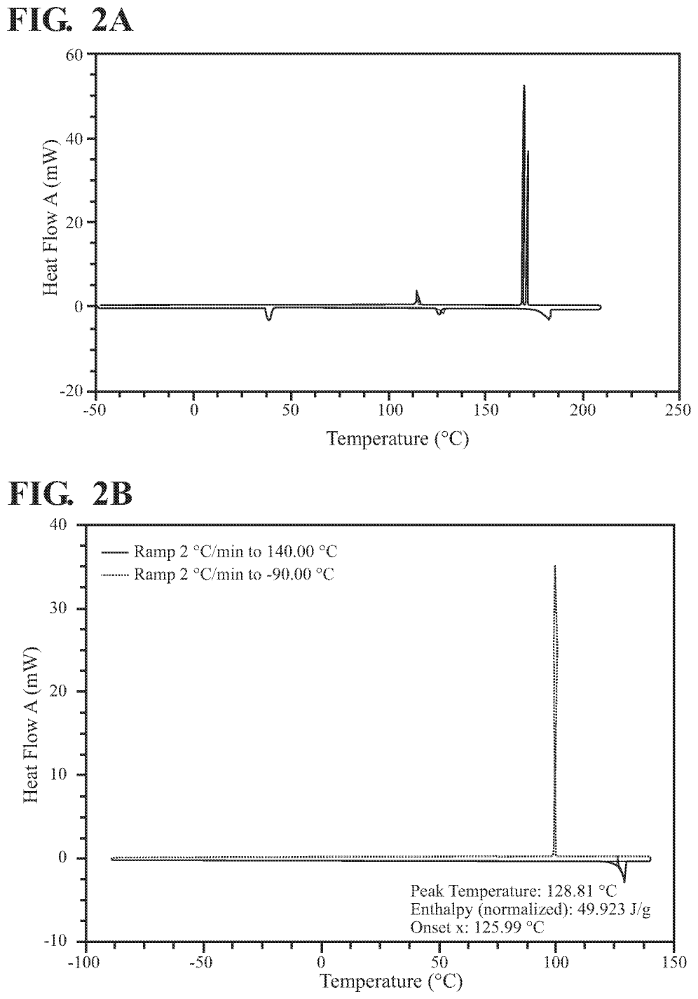

FIG. 4 is a plot showing conductivity at varying temperatures, and at two applied pressures for N2224:CB₁₁H₁₂ doped with LiCB₁₂H₁₂. It is to be noted that the disclosed electrolyte compositions are soft solids, and that their “softness” is quantified based on the amount of pressure needed to obtain maximum ionic conductivity (i.e. harder materials would generally require greater applied pressure to achieve maximum conductivity). To this point, it will be understood that solid-state electrolytes are typically formed into their desired shape by compacting granules or powder of the solid electrolyte, such as in a dye press. Harder materials will require greater pressure to achieve adequate compaction and grain contact, whereas softer materials will be adequately compacted at lower pressure.

The results of FIG. 4 show that the cell having an electrolyte pressed at 1 ton pressure shows stable data within 2 cycles at all temperatures. At 3 tons applied pressure, the conductivity at the second cycle is slightly smaller than that in the first cycle. These results show that low pressures of 1 ton are sufficient to achieve excellent grain to grain contact to obtain the optimum conductivity, and demonstrate the softness of the disclosed electrolyte compositions. For comparison, 1 ton pressure is about ¼ what is needed to form good contacts for state of the art Li sulfide solid state electrolytes.

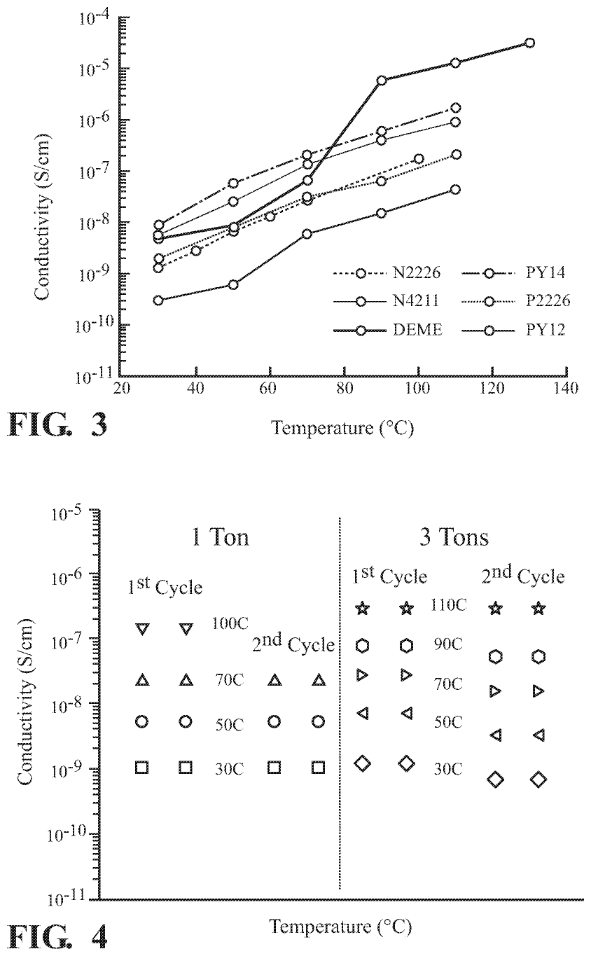

FIG. 5 is a plot of ionic conductivity in Pyr14:CB₁₁H₁₂ doped with LiCB₁₁H₁₂, inset with a photographic image of the soft electrolyte. The electrolyte composition of FIG. 5 is prepared by mixing the components at 125° C. for 15 minutes, followed by cooling to room temperature to yield a solid material. The solid material is then hand milled in a mortar and pestle. The solid powder obtained by this procedure is converted into a round pellet (shown in the inset of FIG. 5) by applying 3 tons of pressure in a dye press. The results demonstrate that very high ionic conductivity can be obtained with the electrolyte compositions of the present teachings, without any need for a phase transition. Absence of grain boundaries, as apparent from sample transparency, in addition to high Li conductivity are shown. Very high Li-ion transference number of 0.86 has also been measured for this material (data not shown) which far exceeds that of all known soft materials such as polymers and all other OIPC type materials (less than 0.5)

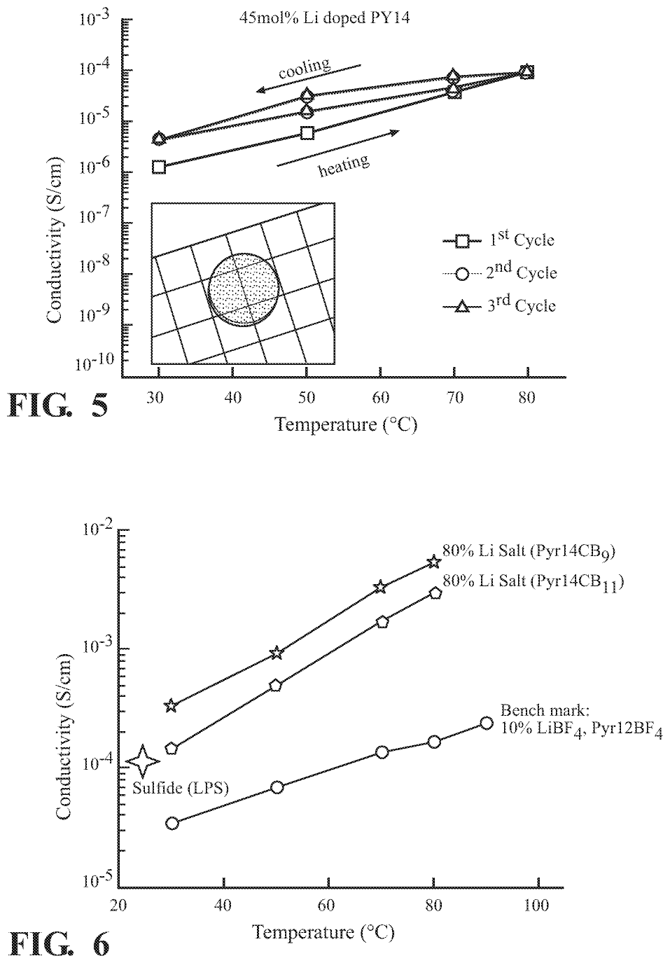

FIG. 6 is a plot of ionic conductivity of different soft electrolytes of the present teachings, having a 1:1 molar ratio of LiCB₉H₁₀:LiCB₁₁H₁₂ as Li salt in Pyr14:CB₉H₁₀ or Pyr14:CB₁₁H₁₂. The compositions of FIG. 6 are prepared by mixing the components using hand milling followed by mixing for 24 hours in a molten state, followed by cooling to room temperature, yielding a solid material. The solid material is hand milled in a mortar and pestle to produce a solid powder. The electrolyte is formed by applying 3 tons pressure in a dye press. It will be noted that the conductivity of the resulting materials is high, compared to a state-of-the-art solid-state electrolyte, lithium phosphorous sulfide (LPS). It will further be noted that LPS grains require pressure of at least 4 tons to achieve useful conductivity, further demonstrating the softness of the electrolyte compositions of the present teachings.

The foregoing description relates to what are presently considered to be the most practical embodiments. It is to be understood, however, that the disclosure is not to be limited to these embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An electrolyte composition for a secondary electrochemical cell comprising:
a soft solid matrix (solid matrix) of the formula GₚA, wherein:
G is an organic cation selected from the group consisting of:
ammonium and phosphonium, having a plurality of organic substituents, each organic substituent of the plurality of organic substituents independently selected from the group consisting of:
(i) a linear, branched, or cyclic C1-C8 alkyl or fluoroalkyl group;
(ii) a C6-C9 aryl or fluoroaryl group;
(iii) a linear, branched-chain, or cyclic C1-C8 alkoxy or fluoroalkoxy group;
(iv) a C6-C9 aryloxy or fluoroaryloxy group;
(v) amino; and
(vi) a substituent that combines two or more of (i)-(v);
wherein at least one organic substituent of the plurality of organic substituents differs from at least one other organic substituent of the plurality of organic substituents;
p is 1 or 2; and
A is a boron cluster anion; and
a metal salt having a metal cation and a metal salt anion.

2. The electrolyte composition as recited in claim 1, wherein the boron cluster anion A, has a formula [B_{y}H_{(y-z-i)}R_{z}Xᵢ]²⁻, [CB_{(y-1)}H_{(y-z-i)}R_{z}Xᵢ]⁻, [C₂B_{(y-2)}H_{(y-t-j-1)}RₜXⱼ]⁻, [C₂B_{(y-3)}H_{(y-t-j)}RₜXⱼ]⁻, or [C₂B_{(y-3)}H_{(y-t-j-1)}RₜXⱼ]²⁻, and wherein:
y is an integer within a range of 6 to 12;
(z+i) is an integer within a range of 0 to y;
(t+j) is an integer within a range of 0 to (y-1);
X is F, Cl, Br, I, or a combination thereof; and
R comprises any of a linear, branched-chain, or cyclic C1-C18 alkyl or fluoroalkyl group; an alkoxy or fluoroalkoxy; and a combination thereof.

3. The electrolyte composition as recited in claim 2, wherein the boron cluster anion A comprises a closo-boron cluster anion.

4. The electrolyte composition as recited in claim 2, wherein the boron cluster anion A comprises at least one of closo-[B₆H₆]²⁻, closo-[B₁₂H₁₂]²⁻, closo-[CB₁₁H₁₂]⁻, or closo-[C₂B₁₀H₁₁]⁻.

5. The electrolyte composition as recited in claim 1, wherein the metal salt anion comprises a boron cluster anion independent of the boron cluster anion A having a formula [B_{y}H_{(y-z-i)}R_{z}X₁]²⁻, [CB_{(y-1)}H_{(y-z-i)}R_{z}Xᵢ]⁻, [C₂B_{(y-2)}H_{(y-t-j-1)}RₜXⱼ]⁻, [C₂B_{(y-3)}H_{(y-t-j)}RₜXⱼ]⁻, or [C₂B_{(y-3)}H_{(y-t-j-1)}RₜXⱼ]²⁻, and wherein:
y is an integer within a range of 6 to 12;
(z+i) is an integer within a range of 0 to y;
(t+j) is an integer within a range of 0 to (y-1);
X is F, Cl, Br, I, or a combination thereof; and
R comprises any of a linear, branched-chain, or cyclic C1-C18 alkyl or fluoroalkyl group; an alkoxy or fluoroalkoxy; and a combination thereof.

6. The electrolyte composition as recited in claim 5, wherein the metal salt anion is a closo-boron cluster anion.

7. The electrolyte composition as recited in claim 5, wherein the boron cluster anion, A, of the soft solid matrix, and the boron cluster anion of the metal salt comprise different anions.

8. The electrolyte composition as recited in claim 5, wherein the boron cluster anion, A, of the soft solid matrix, and the boron cluster anion of the metal salt comprise the same anion.

9. The electrolyte composition as recited in claim 5, wherein the metal salt anion comprises at least one of closo-[B₆H_{6]}²⁻, closo-[B₁₂H₁₂]²⁻, closo-[CB₁₁H₁2]⁻, or closo-[C₂B₁₀H₁₁]⁻.

10. The electrolyte composition as recited in claim 1, wherein the metal salt anion comprises at least one of: (fluorosulfonyl)imide (FSI);
bis(trifluoromethanesulfonyl)imide (TFSI); PF₆; and BF₄ anion.

11. The electrolyte composition as recited in claim 1, wherein the solid matrix comprises at least two different organic cations.

12. An electrolyte composition for a secondary electrochemical cell comprising:
a soft solid matrix (solid matrix) of the formula GₚA, wherein:
G is an organic cation selected from the group consisting of:
ammonium and phosphonium, having a plurality of organic substituents, each organic substituent of the plurality of organic substituents independently selected from the group consisting of:
(i) a linear, branched, or cyclic C1-C8 alkyl or fluoroalkyl group;
(ii) a C6-C9 aryl or fluoroaryl group;
(iii) a linear, branched-chain, or cyclic C1-C8 alkoxy or fluoroalkoxy group;
(iv) a C6-C9 aryloxy or fluoroaryloxy group;
(v) amino; and
(vi) a substituent that combines two or more of (i)-(v);
p is 1 or 2; and
A is a boron cluster anion; and
a metal salt having a metal cation and a metal salt anion wherein the electrolyte composition possesses ionic conductivity greater than 10⁻¹⁰ S/cm in the solid state.

13. The electrolyte composition as recited in claim 12, wherein the metal cation is selected from the group consisting of Li⁺, Na⁺, Mg²⁺, Ca²⁺.

14. The electrolyte composition as recited in claim 12, wherein the metal salt comprises Li(CB₁₁H₁₂), Li(CB₉H₁₀) or their mixtures.

15. The electrolyte composition as recited in claim 12, wherein G comprises an ammonium cation.

16. The electrolyte composition as recited in claim 12, wherein G comprises a phosphonium cation.

17. The electrolyte composition as recited in claim 12, wherein G comprises a pyrrolidinium or piperidinium cation.

18. The electrolyte composition as recited in claim 12, wherein G comprises a DEME cation.

19. The electrolyte composition as recited in claim 12, wherein the metal salt is homogeneously distributed throughout the solid matrix.

20. The electrolyte composition as recited in claim 12, wherein the metal salt is present at a molar ratio, relative to the solid matrix, within a range of from about 1:100 to 100:1, inclusive.
